(19) United States
(12) Patent Application Publication
(10) Pub. No.: US 2007/0150617 A1
(43) Pub. Date: Jun. 28, 2007

(54) Resource application program interface utility for changing user interface elements on wireless devices

(75) Inventor: Keiji Hariki, Sunnyvale, CA (US)

Correspondence Address: COURTNEY STANIFORD & GREGORY LLP, P.O. BOX 9686, SAN JOSE, CA, 95157, US

(73) Assignee: Innopath Software, Inc.

(21) Appl. No.: 11/493,709

(22) Filed: Jul. 25, 2006

Related U.S. Application Data
(60) Provisional application No. 60/753,107, filed on Dec. 22, 2005.

(51) Int. Cl. G06F 15/16

(52) U.S. Cl. 709/246

(57) ABSTRACT

Embodiments of a mobile device incorporating a resource application program interface for downloading user interface components for a resident application are described. Resource profiles are defined by device manufacturers for each model of mobile device. The resource profiles specify the composition, format, and appearance of one or more user interface elements displayed or executed by the mobile device. A content provider maintains a common database of resources for each mobile device model. The resources comprise files, links to files, and/or data or program objects associated with the configurable aspect of the user interface for each mobile device and are provided in the form of a downloadable UI content package consisting of the description file and resource files. The mobile device handset includes a resource API to download UI content package data from a UI content server or UI content that is locally stored. The resource API contains a number of different plug-in content engines and an engine selector component to allow an application program executed on the mobile handset to access the resources without requiring modification of the application.

### CROSS REFERENCE TO RELATED APPLICATIONS

The present application claims priority to U.S. Provisional Application No. 60/753,107, and filed on Dec. 22, 2005.

The present application is related to U.S. patent application entitled “User Interface Authoring Utility for Changing User Interface Elements on Wireless Devices,” filed on Jul. 25, 2006, and assigned to the assignee of the present application.

### FIELD

Embodiments of the invention relate generally to communication networks and more specifically, to a user interface generation system for mobile communication devices.

### BACKGROUND

The development of wireless mobile technology beyond simple point-to-point cell phones has led to the proliferation of mobile devices that are increasingly able to access data from various different sources and process many different types of content data. Mobile services have been developed that allow users to download various types of data and programs, such as games, music, video clips, and so on, for use on their mobile devices. This has led to the expansion of mobile phones beyond mere communication devices, but as processing platforms for a variety of different tasks, and has resulted in the development of various different types of mobile devices to take advantage of these different applications and services. For example, a user may access communication and/or Internet services using a cellular phone, web-enabled mobile phone, home PC, notebook computer, Personal Digital Assistant (PDA), portable game console, electronic mail (e-mail) device, media playback device, and any other type of network enabled computing device. Not only are new types of device being developed, but present known devices, such as the mobile phone, are increasingly becoming integrated devices that are packed with greater capabilities to integrate functions beyond their simple core functions, such as combination phone/camera/MP3 player devices.

The proliferation of different services and devices on wireless networks has led to a great expansion in the different access protocols and user interfaces available on phone and similar devices. In order to help users manage their mobile and network devices, various types of customization capabilities have been provided with wireless devices and communication services. For example, certain mobile phone service and equipment providers provide user interface (UI) customization capabilities that allow users to personalize their phones or mobile devices with custom ringtones, background displays (wallpaper), menu configurations, and the like. The ability to change or customize the colors, fonts, sounds, and functions of the device UI, generally referred to as the “UI skin” can greatly enhance the marketability of a device.

Present UI customization schemes have certain disadvantages, however. For example, many customization features may be buried deep in the native UI or mobile device browser, thus presenting difficult or time consuming operations for the user, and preventing many users from taking full advantage of the possible customization features. Furthermore, present UI customization solutions are typically limited to the basic user interface of a particular device, and are restricted to allowing customization of only a few parameters of the device. Many mobile devices, however, are now capable of performing many different tasks, and even downloading and executing application programs. The customization features of present devices typically do not allow the user to customize features related to the execution of downloadable application programs or utilities, or provide comprehensive customization over all of the functions that may be integrated in the device.

Most device manufacturers provide a single default user interface for each model of device. Customization features, referred to as “UI skin packages,” are often developed and provided by third party vendors. With regard to these third party content providers, providing customization features can involve many labor intensive or high overhead tasks. Each device model on the market may have a unique UI format and specification. With the constant and rapid development and release of new hardware, new resource files must be written and maintained for each new specification of mobile device. At present, the UI skin content providers must typically obtain descriptors or profile parameters for each UI of device from the device manufacturers individually, and compile these into resource files. This can be an often time-consuming process that can also be quite error-prone since it deals with a lot of detailed information.

What is needed, therefore, is a mobile device UI configuration system that allows a UI skin package content provider to easily generate a new UI resource file for new or different mobile devices, and make these UI skin packages available for download and installation on user mobile devices.

What is further needed is a mobile device configuration system that allows modification of mobile device user interfaces or application programs without modification of the application programs themselves.

### BRIEF DESCRIPTION OF THE DRAWINGS

Embodiments of a user interface modification system in a wireless network are illustrated by way of example and not limitation in the figures of the accompanying drawings, in which like references indicate similar elements and in which:

FIG. 1 is a block diagram of a communications network system that implements embodiments of a user interface authoring tool, under an embodiment.

FIG. 2 is a functional diagram of a user interface authoring tool, under an embodiment.

FIG. 3 is an example of a resource profiles for mobile devices, according to an embodiment.

FIG. 4 is a flowchart that illustrates a method providing a user interface authoring tool, according to an embodiment.

FIG. 5 is a block diagram of a mobile device including a resource application program interface for downloading resources for a UI content package, under an embodiment.

FIG. 6 is a more detailed illustration of the resource references for the mobile device of FIG. 5.

FIG. 7 is a flowchart that illustrates a method downloading resources to a mobile device through a resource application program interface on the mobile device, according to an embodiment.

### DETAILED DESCRIPTION

Embodiments of a mobile device incorporating a user interface modification resource application programming interface (API) are described. Aspects of the one or more embodiments described herein may be implemented on one or more computers or computing devices executing software instructions. The computers may be networked in a client-server arrangement or similar distributed computer network. Embodiments are directed to network systems that incorporate a telecommunications or similar wireless network system.

Resource profiles are defined by device manufacturers for each model of mobile device. The resource profiles specify the composition, format, and appearance of one or more user interface elements displayed or executed by the mobile device. A user interface authoring process executed by a content provider maintains a common database of resources for each mobile device model. The resources comprise files, links to files, and/or data or program objects associated with the configurable aspect of the user interface for each mobile device. The customizable aspects or items of a user interface are extracted from selected resource profiles and description files for these aspects are generated using the appropriate common resources. The resources provided by the common resource database are converted to the formats dictated by the resource profiles and a UI package generator produces a downloadable UI content package consisting of the description file and the converted resource files. The mobile device handset includes a resource API to download UI content package data from a UI content server or UI content that is locally stored. The resource API contains a number of different plug-in content engines and an engine selector component to allow an application program executed on the mobile handset to access the resources without requiring modification of the application.

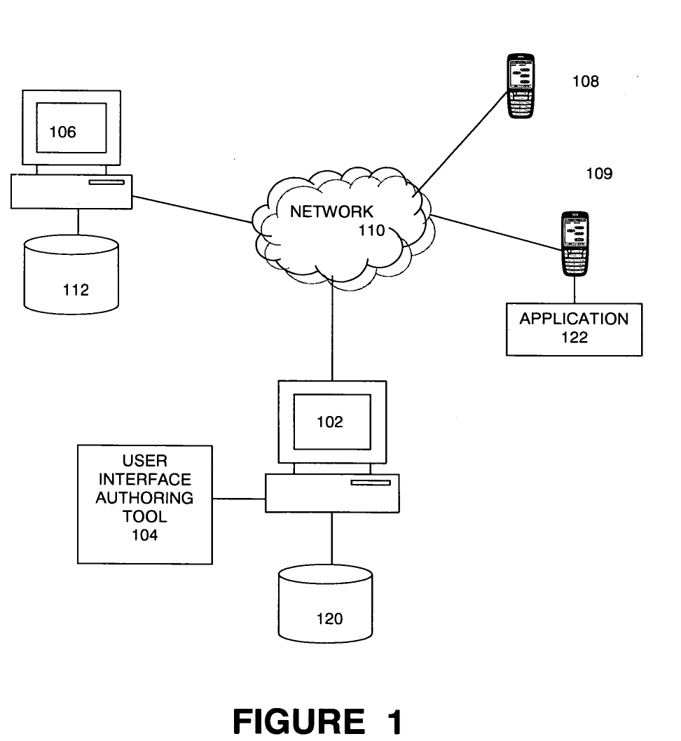

FIG. 1 illustrates a communications network system 100 that implements one or more embodiments of a mobile device UI authoring tool. In system 100, a service provider server computer provides network access to one or more mobile devices, such as mobile phones 108 and 109. In one embodiment, the mobile devices 108 and 109 are cellular phones and network 110 is a comprehensive telecommunications network that includes both a cellular phone network and the Internet. Network 110 may also include one or more Wide Area Networks (WAN), Local Area Networks (LAN), or any combination thereof. The server computer can be a wireless service provider or Internet Service Provider or combination of both. The mobile devices 108 and 109 communicate with each other and other mobile devices over the wireless portion of network 110, over the cellular network. The mobile devices can also be configured to communicate with one or more client and/or server computers that are directly or indirectly coupled to network 110. The mobile devices 108 and 109 can represent devices made by different manufacturers, different models of devices made by the same manufacturer or any type of devices that have different user interface elements from one another.

As shown in system 100, a server computer 102 operated by the service provider or a third party vendor is a content provider server computer that provides content data, application programs, diagnostic tools, program components, or any other content or executable objects to the mobile device 108. The content provider computer can be a World-Wide Web (WWW) server that stores data in the form of web pages and transmits these pages as Hypertext Markup Language (HTML) files over the Internet 110 to the mobile devices 108 and 109, or other client computer on the network. For example, server 102 can executes a web server process to serve web pages over network 110. For this embodiment, one or more of the mobile devices runs a web browser program to access the web pages served by server computer 102 and any other available content provider or supplemental server, such as computer 106.

Any or all of the client computers in system 100 may be a workstation computer or they may be a computing device such as a notebook computer, personal digital assistant, or the like. The client computers may also be embodied within a mobile communication device, game console, or similar computing device that provides access to the Internet network 110 and a sufficient degree of user input and processing capability to execute or access the application programs. The mobile devices 108 and 109 may be coupled to the network 110 over a wired connection, a wireless connection or any combination thereof.

In a typical implementation, a great number of mobile devices of various types and makes can be interconnected through network 110. Because no strict industry standards have been written to dictate a uniform user interface among the possible different mobile devices, each mobile device can feature a different user interface. In general, each manufacturer of a mobile device may have a certain style of user interface, but even devices provided by the same manufacturer can feature very different user interfaces to one another. The ability of users to customize their user interfaces increases the variation of user interface styles even more.

In one embodiment, server computer 102 is operated by a content provider that can generate a customized user interface for a plurality of different makes and types of mobile devices, such as cell phones 108 and 109. For purposes of discussion, the customized user interface is referred to as a “UI skin.” In general, UI skins allow a user to customize the “look and feel” or application program environment of a device by altering display and/or sound output aspects of the device, such as backgrounds, title bars, buttons, alert sounds, and so on. Some programs make automatic skin changes for a user when the user starts the program or uses certain parts of the program; alternatively UI skins can be downloaded by the user and installed on the mobile device to alter the default UI or permanently change the UI of the device. UI skins may be developed by third party vendors, device manufacturers, application writers, and so on. In general, different categories of UI skins can be developed for different types of mobile devices and different makes of mobile devices.

As shown in FIG. 1, server computer 102 is operated by a content provider, and executes a user interface authoring tool 104 that generates a content package for each mobile device and downloads the user interface to the appropriate mobile device upon request of the mobile device user. Various resource profiles and resource files for the different mobile devices can be stored in a database or data store 120 coupled to the server computer 102. Alternatively, the resource profiles and other associated data files can be stored in a remote data store, such as data store 112 maintained by workstation 106.

In one embodiment, the mobile devices 108 and 109 are delivered to the users with a default user interface that presents a set UI skin consisting of a particular screen configuration, size, color scheme, font, menu scheme, keypad button assignment, ringtone selection, and so on. Many different aspects of a mobile device may be customizable however, such as the format and display of menus, commands, subwindows, and so on. The content provider 102 can provide a customized UI that allows the user to change certain aspects of the UI skin. The resource files dictating the parameters that can be changed are stored in data store 120 or data store 112.

In system 100, User interface descriptor information comprising the customizable UI elements are downloaded to a mobile device, such as 108 or 109. In one embodiment, the UI descriptor information can comprise screen parameter definitions (e.g., size, aspect ratio, icon definitions, and so on), images, video clips, music or other sound clips, ringtones, games, small applications (applets), utilities, diagnostic tools, or any other similar data or applications, all of which are referred to as “UI content objects.” UI Content objects can be provided by a number of different content providers, such as content provider 102 or 106. Typically customized UI content is downloaded upon demand, such as when the user requests a UI upgrade or modification from a particular content provider. Alternatively, UI skin content can be pushed to the user from a content provider based on a periodic subscription arrangement, trial use, or similar mechanism. In one embodiment, the UI content objects are generated and made available for download through the user interface authoring tool 104 executed by server computer 102. The user interface authoring tool 104 can represent a program or suite of programs, or even hardware circuits, or any combination thereof embodying instructions executed by one or more processing units in server 102.

### Server-Based UI Authoring Tool

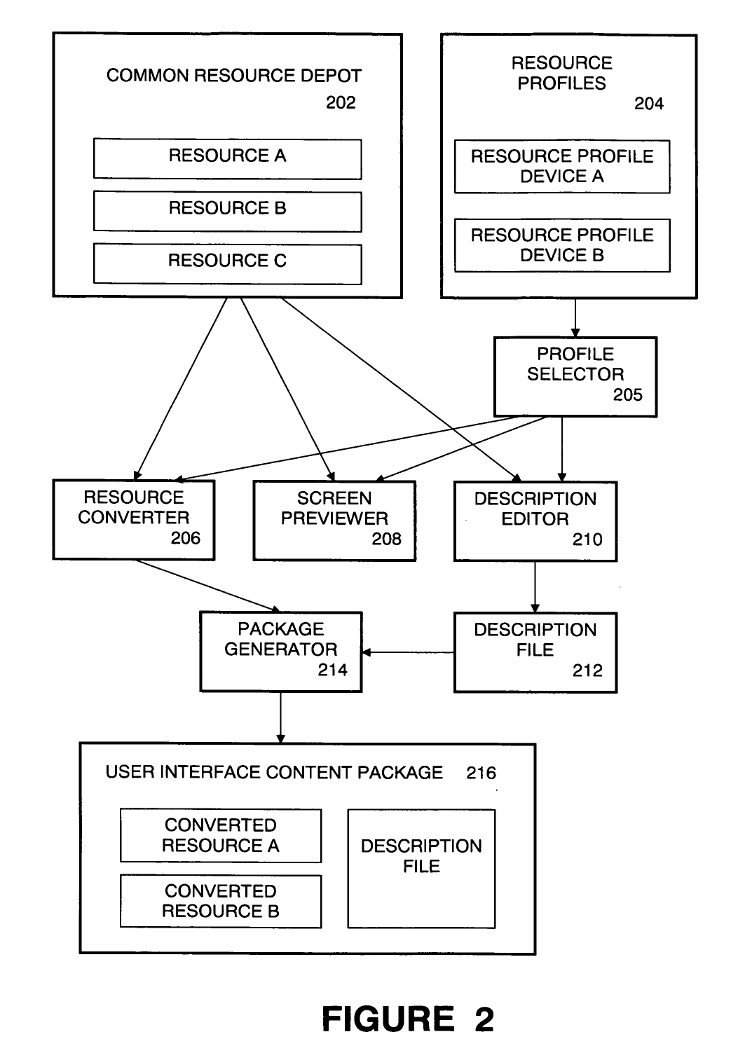

FIG. 2 is a functional block diagram of a user interface authoring system, under an embodiment. The UI authoring system allows content providers to create content packages embodying UI skins for distribution and downloading to mobile devices on the network. The content package for each UI skin contains information specific to the type of device, manufacturer of the device, operating system, application programs, and other relevant information regarding the mobile device.

For the system illustrated in FIG. 2, UI skin package data specific to each mobile device is generated from common resource data using resource profile information for each mobile device model. The model of a device generally refers to the make (manufacturer) of a device and the specific model, type, or version of the device, as specified by the manufacturer. Through the use of the UI authoring tool, a content creator can create UI skin content packages for each possible model of mobile device used on the network without preparing separate resource files for each model.

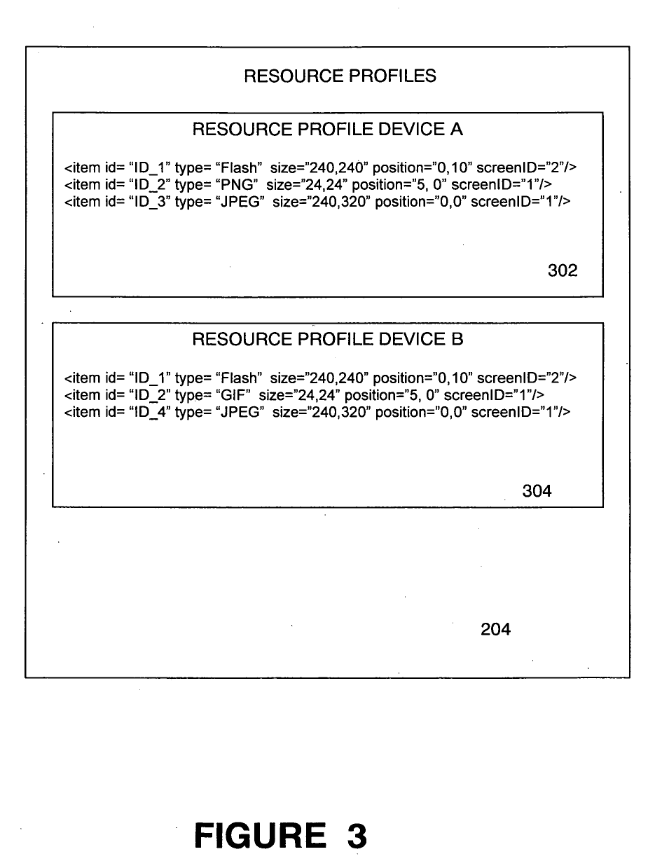

The user interface specifications for each mobile device are provided by the device manufacturers and are stored in a resource profiles database 204. The user interface specifications generally describe all relevant aspects of a UI element with regard to the device and any application programs that may be used on the device. Each type or model of mobile device has an associated resource profile. Thus, as shown in FIG. 2, a resource profile is provided for device A, and a resource profile is provided for device B. With reference to FIG. 1, these can correspond to resource profiles for mobile devices 108 and 109, respectively. The composition and format of the resource profiles are described later and in greater detail with respect to FIG. 3.

A common resource depot 202 contains resources, such as those denoted resource A, resource B, and resource C. The resources comprise files, links to files, and/or data or program objects associated with the configurable aspect of the user interface for each mobile device. Thus each resource (also referred to as a “resource file”) in resource depot 202 represents a file, location, directory, link, document, or similar object that contains or references information or data elements pertaining to the aspects of the mobile device that can be configured or customized. All of the pertinent information relating to a mobile device is stored in a resource file, and all of the resource files for the possible different mobile device types are stored in a common resource depot 202. The resource files can contain various types of data objects relating to the user interface elements of the mobile devices, such as image files, sound files, screen layouts, icons, movies, and so on. The common resource depot 202 can be implemented as a database stored in a data store 120 maintained by the content provider 102 or a data store 112 maintained by a separate server 106.

The profile selector 205 selects a resource profile 204 depending upon the device model selected by the content provider. The corresponding resource 202 for that model is then converted by resource converter 206. The resource converter 206 can be configured to perform various different types of conversion operations, such as converting file formats (e.g., PNG to JPEG), changing color formats (e.g., monochrome to 8-bit color), and so on. The resource converter 206 converts each resource into a format corresponding to the resource profile. A screen previewer component 208 provides a utility to preview the user interface for the device based on the resource files.

A description editor component 210 produces description files 212 based on the selected resource profile 204 and resource file 202. A description file 212 specifies the resources and the file type, and file path name. The description file 212 and the converted resource output from resource converter 206 are processed by a package generator component 214. The package generator 214 takes the resource and description and creates a UI content package 216. The UI content package contains the UI skin for the target mobile device and contains images or data for the various UI elements, such as image files, movie files, and/or sound files. The UI content package comprises the appropriate converted resources and the description file.

The package generator can be configured to produce the UI content package in variety of different formats, such as an archived file, an encrypted file, or a file that contains supplemental information, such as that provided by a supplemental content provider.

In one embodiment, the resource profiles 204 are files or data objects that are provided by device manufacturers for each mobile device. FIG. 3 is an example of the format of possible resource profiles for mobile devices, according to an embodiment. The resource profiles specify the type, format, size, placement, and various other parameters for each user interface element for the device. For the example shown in FIG. 3, the resource profile for device A includes a number of items, each referenced by a unique item ID. Thus, for example, item 1 is a Flash file, that is displayed on a 240×240 pixel space at position 0, 10 on screen 2 of the device. Likewise, item 2 is a PNG file of size 24 by 24 displayed at position 5.0, and so on. Similarly, device B has a number of UI elements specified by a number of items, as shown. FIG. 3 illustrates one exemplary format for the device resource profiles, and many other types of resource file formats are possible depending upon the device types and manufacturer specifications. The resources 202 are converted into a format that corresponds to the appropriate resource profile 204. Thus, if the resource is an image, it is converted to the appropriate size and file format according to the resource profile.

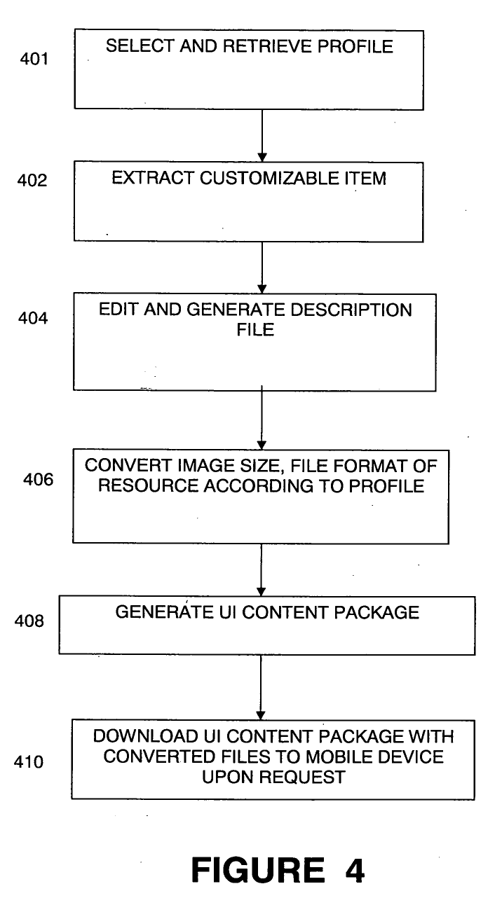

FIG. 4 is a flowchart that illustrates a method of generating and downloading UI skins, according to an embodiment. The method begins in step 401 with selection and retrieval of the appropriate resource profile for the device from the resource profiles 204. In step 402, the profile selector extracts the customizable items within the UI elements. Not all elements of a UI may be customizable, and the process only handles elements of the UI that are customizable. The description file is then generated by the description editor, step 404. At this time, the resource converter converts the image sizes, and file formats of the resources according to the profile, step 406. The package generator then creates the UI content package, step 408. The UI content package can then be downloaded to the target mobile device, step 410.

Through the system and process illustrated in FIGS. 2 through 4, the UI authoring tool allows the content creator to create a UI skin content package for each possible mobile device type without requiring the preparation of separate resource files for each device. Through the use of the pre-defined resource profiles, and the appropriate editing and conversion components, a common resource file database can be used to generate different UI content packages for each mobile device in a network.

In one embodiment, the mobile device executes an application 122 that utilizes the resources provided by the content provider. This application might be an object displayed on the screen of the mobile device or a played through a playback circuit (sound or video) of the mobile device, or it may be an executable module (applet) executed by the mobile device. The resources comprising the UI content package to be downloaded to the mobile device for use by the application may be provided by an external content provider, as shown in FIG. 1. Alternatively, the UI content package may be pre-installed on the mobile device itself.

In general, regardless of the source of the UI content package, the resources referenced by the descriptor file and utilized by the application must be referenced in some way by the application and then retrieved and converted to an appropriate format for use by the application. In one embodiment, the content server performs the necessary resource retrieval and conversion operations and downloads the resources directly to the mobile device. In this embodiment, the resource profiles 204 specify the appropriate formats required. In another embodiment, the mobile device handset itself contains components to facilitate the downloading and conversion of resource files or data objects from common UI package content for use in resident application programs.

### Resource API-Based Mobile Devices

In one embodiment, a mobile device in network 100 is configured to convert the file format from the common UI package directly in the handset itself. As shown in FIG. 1, the mobile device (also referred to as a “handset”) is configured to run one or more application programs 122 or software modules to execute or access the resources provided by the UI content package. The applications can be any program that can playback or perceive the image, video, sound files, etc. of the resources provided by the UI content package. The UI content package may be authored and provided by a content server 102, as illustrated and described with reference to FIGS. 1-4, or it may be UI content produced and provided by an alternate method.

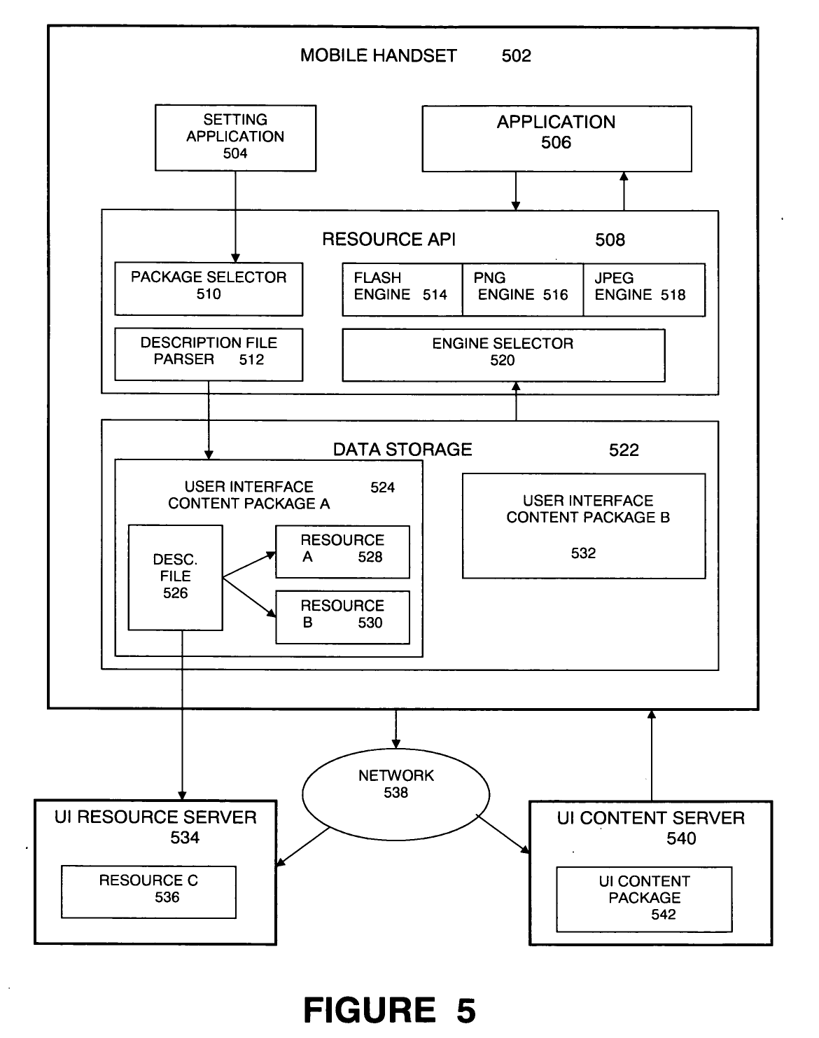

FIG. 5 is a block diagram of a mobile device including a resource configured to download resources for a UI content package, under an embodiment. The mobile handset 502 executes an application program 506 that uses one or more resources for a UI content package. The mobile handset 502 also has a resource application program interface (API). The application 506 refers to UI resources by resource ID number rather than by file name or directory (storage location) path directly. The resource API thus provides a level of resource reference abstraction and facilitates the portability of resources in the system. The application 506 may be a software program or utility that alters the appearance or functionality of the mobile device, or it may be a program that, when executed, provides a service to the user, or any other functionality.

Through the resource API functionality, the mobile device is able to change the UI skin of the application 506 by UI content packages that are downloaded from a UI content server or are pre-installed in the mobile handset, without requiring modification of the application itself. Applications can also access the resources of various file types without requiring modification or implementation changes. Resource files can be placed in the handset itself or on server computers coupled to the mobile handset over the network. Different UI specifications can be accommodated for each device by converting the resource format through the resource API, without requiring modification of the application and the UI content packages.

As shown in FIG. 5, the resident application 506 is functionally coupled to resource API 508, which contains a number of functional components such as package selector 510, description file parser 512, an engine selector 520, and one or more engines, such as Flash engine 514, PNG (portable network graphics) engine 516, JPEG (joint photographic experts group) engine 518, and any other similar engines. These engines process the applicable resource using the appropriate playback format depending upon the type of data or program elements in the resource. Thus, for example, the resource is an applet, the flash engine 514 is invoked, and if the resource is a photograph, the JPEG engine 518 is invoked, and so on.

The actual UI content package to be downloaded is generally selected by the user of the mobile device. A setting application 504 sets the UI content package data for the application program, and the user can change the UI content by changing the setting application 504. As shown in FIG. 5, the setting application 504 selection is input to a package selector module 510 in the resource API 502.

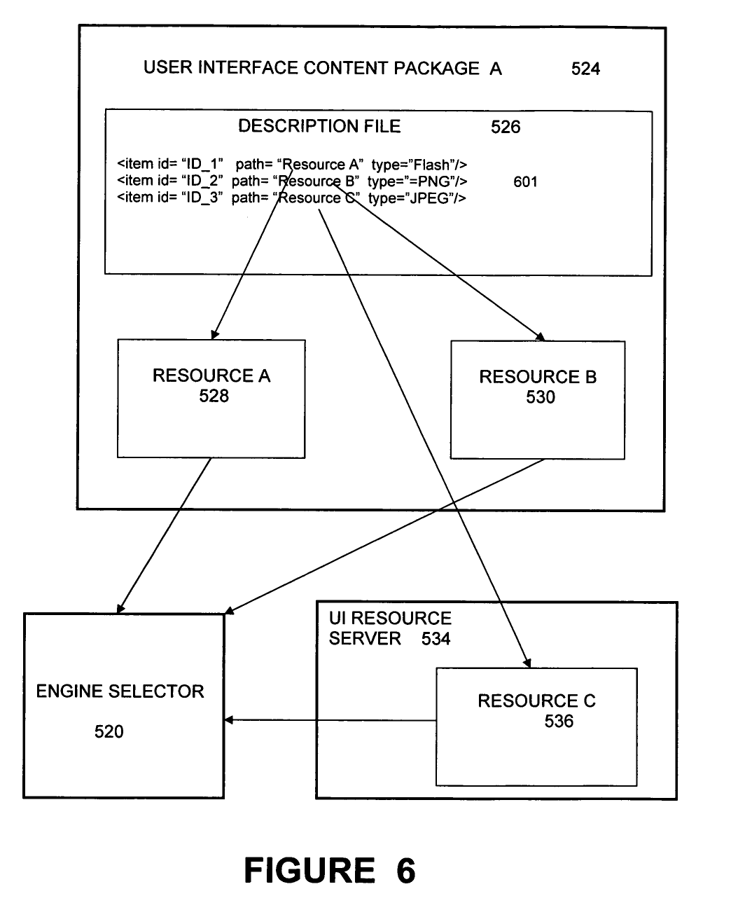

The mobile handset 502 also includes a data storage component 522, which can be implemented as any type of fixed, removable or on-board memory device. One or more user interface content packages 524 and 522 can be stored in this data storage. Each user interface content package contains a description file 526 and one or more resources 528 and 530. The UI content packages stored on the data storage 522 of the mobile handset are typically pre-installed on the handset by the manufacturer of the device or a third party entity that provided configuration support. UI content packages can also be provided by external sources over network 538, such as from UI content servers, such as content server 540, which contains UI content package 542. Such a content server may correspond to either the server 102 or server 106 of FIG. 1. Each UI content package 542 provided by an external content provider server also contains a description file and one or more resources, the contents of which are described in greater detail below with reference to FIG. 6.

The description file parser 512 selects the appropriate description file for the package selected by package selector 506. In general, a description file describes the information of the resource files contained in the UI content package. The description file contains references to one or more resources to be downloaded to the application 506. The description file 526 may reference resources contained within the same UI content package, or it may reference resources in other content packages that are either in pre-installed in the mobile handset or on an external server computer. For the example illustrated in FIG. 5, the description file 526 reference resource A 528 and resource B 530, which are contained in the UI content package A 524 resident in the mobile device data storage 522, as well as resource C 536 which is provided by a UI resource server 534. Resource server 534 represents a server computer or network resource that provides resources that have not been packaged into UI content packages, such as UI content package 542. Such a resource server may correspond to either the server 102 or server 106 of FIG. 1.

The resource API 508 retrieves each resource referenced by the description file selected for the UI content package selected by the package selector 510 and the description file parser 512. The engine selector component 520 of the resource API selects the proper engine, which then converts each resource file to a format or embodiment that is compatible with the application 506. The application dictates the format of the resource in terms of parameters such as image size, color, position, and so on.

FIG. 6 is a more detailed illustration of the user interface content package and resource references for the mobile device of FIG. 5. As illustrated in FIG. 6, user interface content package A 524 contains a description file 526. The description file contains a number of item entries 601. Each item entry consists of certain items of information, such as identifier (ID), path (location), and file type, among other parameters, relating to a particular resource. Thus, as illustrated in FIG. 6, three example entries are illustrated for Resources A, B, and C. Resource A is a flash object, Resource B is a PNG object, and Resource C is a JPEG object.

The path parameter specified the location of the resource, and can be implemented as a pointer or as a link to a storage location. In general, the application 506 on the mobile device does not refer to resources by location, but rather by ID. The description Resource API accesses the appropriate description file which correlates the proper resource location to the resource ID for upload to the application. In this manner, the resource API 508 represents an abstracted interface between the application and the actual resources. As shown in diagrammatically in FIG. 6, the path element of each item descriptor effectively points to the location of the corresponding resource. Thus, as shown, the link “Resource A” points to resource A 528, and the link “Resource B” points to resource B 530, and the line “Resource C” points to resource A 536. The resources referenced by the description file can be contained in the same UI content package as the descriptor file, such as for Resources A and B, or they can be provided by in another UI content package (either in the mobile handset or in an external UI content server 540), or an external UI resource server 536, such as shown in FIG. 6. The selected resources are then input to the engine selector component 520 of the resource API 502 for processing by the appropriate engine.

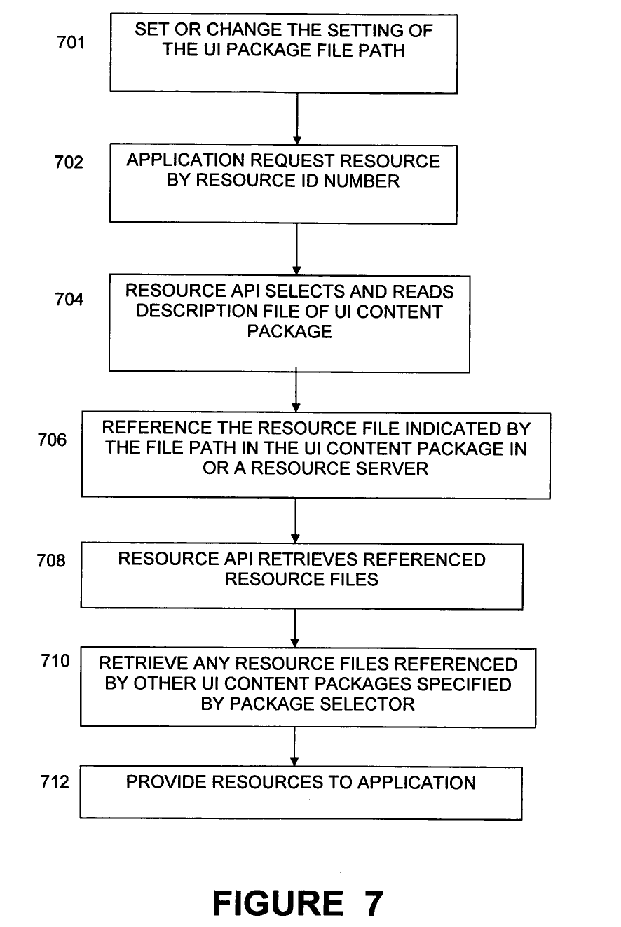

FIG. 7 is a flowchart that illustrates a method downloading resources to a mobile device through a resource API on the mobile device, according to an embodiment. In step 701, the setting application sets or changes the setting of the UI package file path. In step 702, the application on the mobile handset requests a resource by specifying the resource ID (e.g., ID_1). The package selector 510 and description file parser 512 use the package file path and resource ID number to locate the appropriate UI content package containing the referenced resource. As shown in block 704, the resource API selects and reads the description file for the selected UI content package. The resource or resources may be contained in a single UI content package specified by the package selector, or they may be contained in different content packages either within or external to the mobile device. The description file references the resource file indicated by the file path in the UI content package or a resource server, or other external source, step 706. This reference step is functionally illustrated in FIG. 6.

After the selected resources have been properly referenced and located, they are retrieved by the resource API and input to the engine selector for processing by the appropriate engine, step 708. As shown in block 710, other UI content packages, such as 542, can be specified by the package selector, in which case those resources are also retrieved. The resource API then uploads all referenced resources to the application, step 712. As shown by the process of FIG. 7, the application can gain access to local or external resources by simply specifying a resource ID, rather than the location of a resource. In this manner, changes can be made to resources through the use of different content packages or implementation in updateable UI resource servers, without requiring any change to the application program 506 itself. Furthermore, elements of the resource API 508 can be modified or upgraded without requiring a change to the application program. For example, different or new versions of engines for different types of data objects or programs can be implemented in the resource API by adding or modifying the engine components.

Although embodiments of the UI authoring system and mobile handset system described herein have been described with respect to networks of mobile communication devices, such as cellular phones, it should be noted that alternative embodiments can be directed to any type of computing device that has a user interface that can be configured or modified using a UI skin or descriptor file. Such devices can be wired or wireless computers, workstations, embedded processing devices, and so on. Embodiments can also be implemented in user interface module provided in machinery, such as the UI interfaces in cars, planes, boats, and so on.

Aspects of the UI authoring and mobile handset system described herein may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects of the method include: microcontrollers with memory (such as EEPROM), embedded microprocessors, firmware, software, etc. Furthermore, aspects of the described method may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of the UI authoring and mobile handset system is not intended to be exhaustive or to limit the embodiments to the precise form or instructions disclosed. While specific embodiments of, and examples for, the UI authoring system are described herein for illustrative purposes, various equivalent modifications are possible within the scope of the described embodiments, as those skilled in the relevant art will recognize.

The elements and acts of the various embodiments described above can be combined to provide further embodiments. These and other changes can be made to the disclosed system in light of the above detailed description.

In general, in any following claims, the terms used should not be construed to limit the described system to the specific embodiments disclosed in the specification and the claims, but should be construed to include all operations or processes that operate under the claims. Accordingly, the described system is not limited by the disclosure, but instead the scope of the recited method is to be determined entirely by the claims.

While certain aspects of the UI authoring and mobile handset system may be presented in certain claim forms, the inventor contemplates the various aspects of the methodology in any number of claim forms. For example, while only one aspect of the system is recited as embodied in machine-readable medium, other aspects may likewise be embodied in machine-readable medium. Accordingly, the inventor reserves the right to add additional claims after filing the application to pursue such additional claim forms for other aspects of the described systems and methods.

What is claimed is:

1. A method of obtaining a resource for use by an application on a mobile device, comprising:
referencing a resource through the application by a resource identifier;
locating the referenced resource in a user interface content package, the user interface content package comprising a description file containing a path specifying a location of the referenced resource;
inputting the referenced resource in a processing engine to convert one or more resource data objects to a format compatible with the application.

2. The method of claim 1 wherein the resource comprises one or more data objects that comprise user interface elements of the mobile device.

3. The method of claim 1 wherein the resource comprises one of an image, a video clip, and a sound clip.

4. The method of claim 3 wherein the processing engine comprises at least one of a Flash engine, a PNG engine, and a JPEG engine.

5. The method of claim 2 wherein the resource identifier comprises an alphanumeric reference that does not directly indicate a location of the resource.

6. The method of claim 3 wherein the resource is contained in the user interface content package containing the description file.

7. The method of claim 3 the resource is contained in a user interface content package on a server computer coupled to the mobile device over a network.

8. The method of claim 3 wherein the description file contains descriptors containing the resource identifier, the location of the resource specified by the resource identifier, and a file type of the resource specified by the resource identifier.

9. The method of claim 1 wherein the mobile device comprises at least one of a cellular phone, a personal digital assistant device, a notebook computer, and a game console.

10. An apparatus for obtaining a resource for use by an application on a mobile device, comprising:
a data store storing a one or more user interface content packages, each containing a description file and one or more resources; and
a resource application programming interface configured to:
locate a resource specified by the application, the resource containing one or more data objects;
convert the resource data objects to a format compatible with the application; and
upload the resource to the application on the mobile device.

11. The apparatus of claim 10 wherein the resource comprises one or more data objects that comprise user interface elements of the mobile device.

12. The apparatus of claim 11 wherein the resource comprises one of an image, a video clip, and a sound clip.

13. The apparatus of claim 12 wherein resource application programming interface includes a processing engine component that comprises at least one of a Flash engine, a PNG engine, and a JPEG engine.

14. The apparatus of claim 10 wherein application specified the resource through an alphanumeric reference that does not directly indicate a location of the resource.

15. The apparatus of claim 14 wherein the referenced resource is contained one of the user interface content package containing the description file, and in a user interface content package on a server computer coupled to the mobile device over a network.

16. The apparatus of claim 15 wherein the description file contains descriptors containing the resource identifier, the location of the resource specified by the resource identifier, and a file type of the resource specified by the resource identifier.

17. The apparatus of claim 16 wherein the mobile device comprises at least one of a cellular phone, a personal digital assistant device, a notebook computer, and a game console.

18. A computer-readable medium including executable instructions, which when executed in a processing system, obtain a resource for use by an application on a mobile device by:
referencing a resource through the application by a resource identifier;
locating the referenced resource in a user interface content package, the user interface content package comprising a description file containing a path specifying a location of the referenced resource;
inputting the referenced resource in a processing engine to convert one or more resource data objects to a format compatible with the application.

19. The medium of claim 18 wherein the resource comprises one of an image, a video clip, and a sound clip.

20. The medium of claim 19 wherein the referenced resource is contained one of the user interface content package containing the description file, and in a user interface content package on a server computer coupled to the mobile device over a network.
